(19) United States
(12) Patent Application Publication
(10) Pub. No.: US 2011/0193759 A1
(43) Pub. Date: Aug. 11, 2011

(54) Antenna Device

(76) Inventor: You-Cheng You, Jhongli City (TW)

(21) Appl. No.: 12/701,777

(22) Filed: Feb. 8, 2010

(51) Int. Cl. H01Q 13/10

(52) U.S. Cl. 343/770

(57) ABSTRACT

An antenna device includes an antenna radiation portion, a reflection portion and a connecting portion. The reflection portion and the antenna radiation portion are installed in parallel with each other at both ends of the connecting portion respectively, such that the connecting portion is connected to the antenna radiation portion and the reflection portion, and the antenna radiation portion and the reflection portion are formed by integrally bending a metal plate to reduce interferences caused by other external factors, so as to achieve the expected directivity, lower the production cost, and shorten the manufacturing time.

### BACKGROUND OF THE INVENTION

1. Field of the Invention

The present invention relates to an antenna device, and more particularly to an antenna device having an antenna radiation portion and a reflection portion formed on a same object to lower the production cost and shorten the manufacturing time.

2. Description of the Related Art

For wireless communication products, an antenna for transmitting and receiving electromagnetic signals is a necessary key component. Antennas are mainly divided into omni-directional antennas and directional antennas according to the transmitting and receiving direction.

For example, a directivity antenna device uses a reflection plate to reflect an electromagnetic wave emitted by the antenna and guide the electromagnetic wave to travel in a fixed direction, so as to enhance the directivity and gain of the antenna device.

In the conventional antenna device, a plurality of through holes are formed on an antenna substrate, and a plurality of screw bolts corresponding to the through holes are installed on the reflection plate, such that the plurality of screws can be passed through the through holes of the antenna substrate and secured onto the screw bolts respectively, such that the antenna substrate can be fixed onto the reflection plate.

In a conventional screw connection for fixing the antenna substrate and the reflection plate, the reflection plate includes a plurality of screw bolts installed thereon, and thus the reflection plate must be designed with a specific thickness for securely holding the screw bolts and preventing the reflection plate from being deformed by a heavy load. However, the increased thickness of the reflection plate incurs higher manufacturing and production costs.

In the process of mounting the antenna substrate, users have to repeat the screwing process, which takes much time and gives rise to an inconvenient installation, and the repeated screwing process also creates more external factors that may affect the directivity of the antenna device. Furthermore, too many screw bolts will occupy a large area of the reflection plate, such that the overall volume of wireless communication products cannot be minimized, and the manufacturing cost will be increased. Obviously, the conventional antenna device is unable to meet the requirements for a light, thin, short and compact design of the wireless communication products or the user requirements for a good communication performance.

### SUMMARY OF THE INVENTION

In view of the shortcomings of the prior art, the inventor of the present invention based on years of experience in the related industry to conduct extensive researches and experiments, and finally developed an antenna device in accordance with the present invention to overcome the shortcomings of the prior art.

Therefore, it is a primary objective of the present invention to overcome the aforementioned shortcoming and deficiency of the prior art by providing an antenna device having an antenna radiation portion and a reflection portion formed on a same object to lower the production cost and shorten the manufacturing time.

To achieve the foregoing objective, the present invention provides an antenna device comprising an antenna radiation portion, a reflection portion and a connecting portion, wherein the antenna radiation portion includes a longer slot hole, a shorter slot hole and a feeding point, and the reflection portion and the antenna radiation portion are disposed in parallel with each other and at both ends of the connecting portion respectively, such that the connecting portion is coupled to the antenna radiation portion and the reflection portion, and the antenna radiation portion and the reflection portion are formed by integrally bending a metal plate to reduce interferences caused by other external factors, so as to achieve the expected directivity, lower the production cost, and shorten the manufacturing time.

In addition, the longer slot hole is provided for generating a first operating band of the antenna device, and the shorter slot hole is provided for generating a second operating band of the antenna device, such that the antenna device is applicable for a dual-band operation with a low frequency (2.4 GHz) and a high frequency to fit both low-frequency and high-frequency operations of a wireless area network.

### BRIEF DESCRIPTION OF THE DRAWINGS

FIG. 1 is a perspective view of an antenna device in accordance with a first preferred embodiment of the present invention;

FIG. 2 is an exploded of an antenna device in accordance with a first preferred embodiment of the present invention;

FIG. 3 is a perspective view of an antenna device in accordance with a second preferred embodiment of the present invention;

FIG. 4 is a schematic view of an antenna device in accordance with a second preferred embodiment of the present invention;

FIG. 5 is a schematic view showing an electrical test results for different included angles of an antenna device in accordance with the present invention;

FIG. 6 is a schematic view of a MIMO structure applied in an antenna device in accordance with the present invention.

### DETAILED DESCRIPTION OF THE PREFERRED EMBODIMENTS

The technical characteristics of the present invention will become apparent with the detailed description of the preferred embodiments and the illustration of the related drawings.

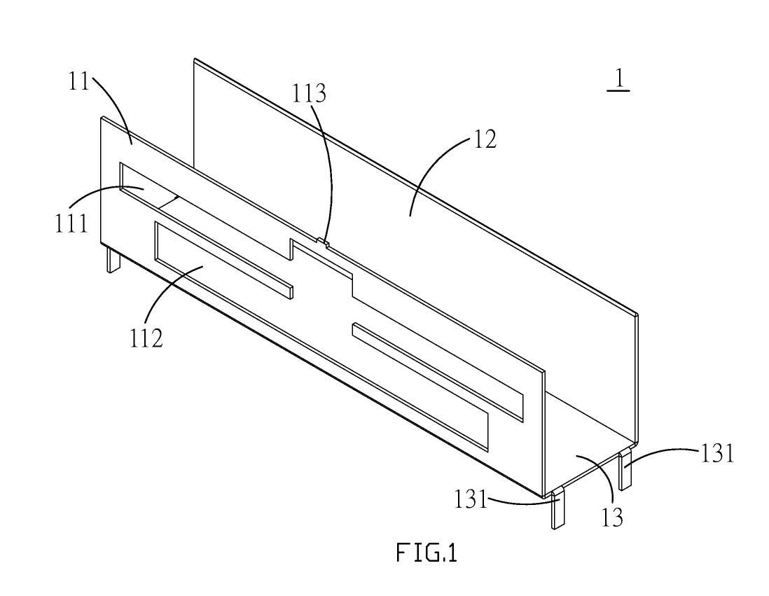

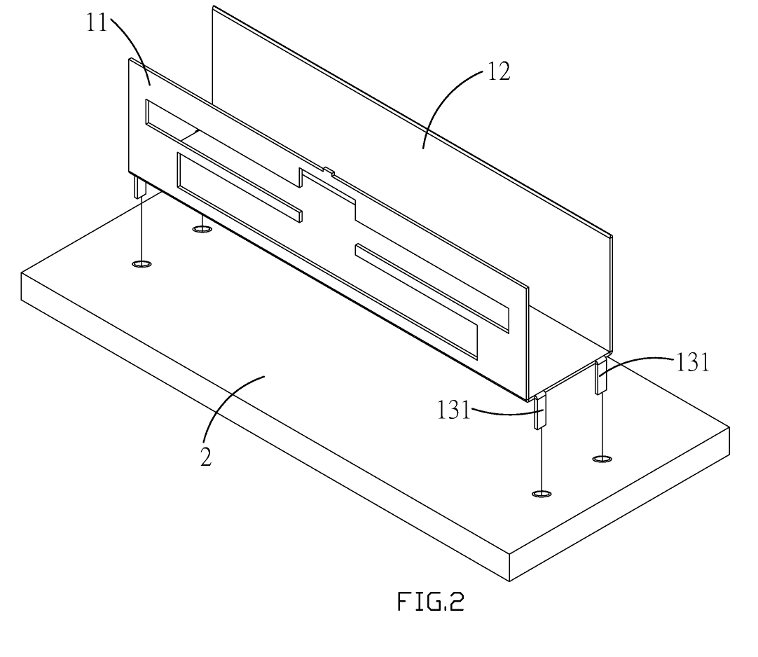

With reference to FIGS. 1 and 2 for an antenna device 1 of the present invention, the antenna device 1 comprises:

an antenna radiation portion 11, having a longer slot hole 111, a shorter slot hole 112 and a feeding point 113, and the feeding point 113 being disposed at a central position of the longer slot hole 111 or the shorter slot hole 112;

a reflection portion 12, disposed in parallel with the antenna radiation portion 11 and having a same height as the antenna radiation portion 11 and the reflection portion 12; and

a connecting portion 13, disposed between the antenna radiation portion 11 and the reflection portion 12, for connecting the antenna radiation portion 11 and the reflection portion 12, and the connecting portion 13 having a plurality of fixing portions 131 disposed around the periphery of the connecting portion 13 and provided to be installed onto a substrate 2.

The antenna radiation portion 11 and the reflection portion 12 of the antenna device 1 are formed by integrally bending a metal plate, and the reflection portion 12 forms a fixed interval by the connecting portion 13 and the antenna radiation portion 11, and the antenna radiation portion 11 reflects an electromagnetic wave emitted from the antenna by a reflection plate that is parallel to the antenna radiation portion and guides the electromagnetic wave to travel in a fixed direction to enhance the directivity and gain of the antenna device, and reduce the interference caused by other external factors, so as to achieve the expected directivity, lower the production cost and shorten the manufacturing time. In addition, the longer slot hole of the antenna device 1 is capable of generating a first (low-frequency) operating band, and the shorter slot hole of the antenna device 1 is capable of generating a second (high-frequency) operating band to provide a dual-band operation.

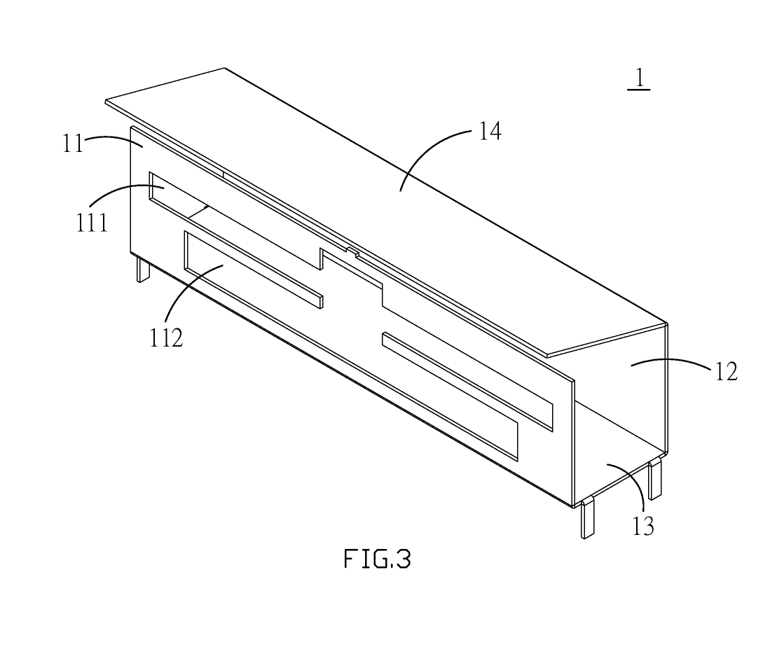

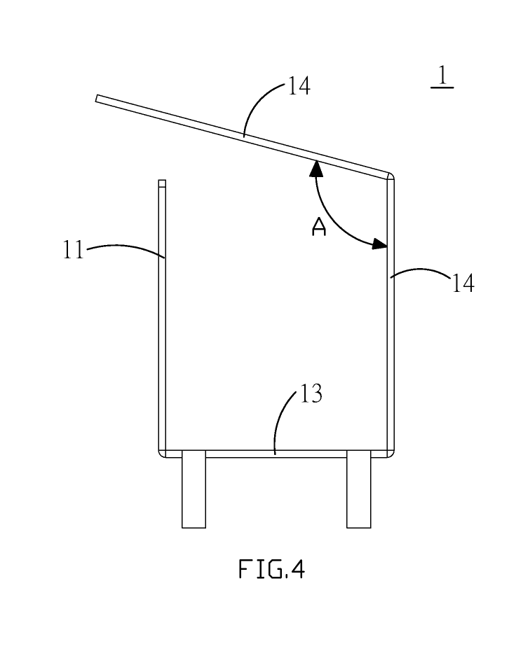

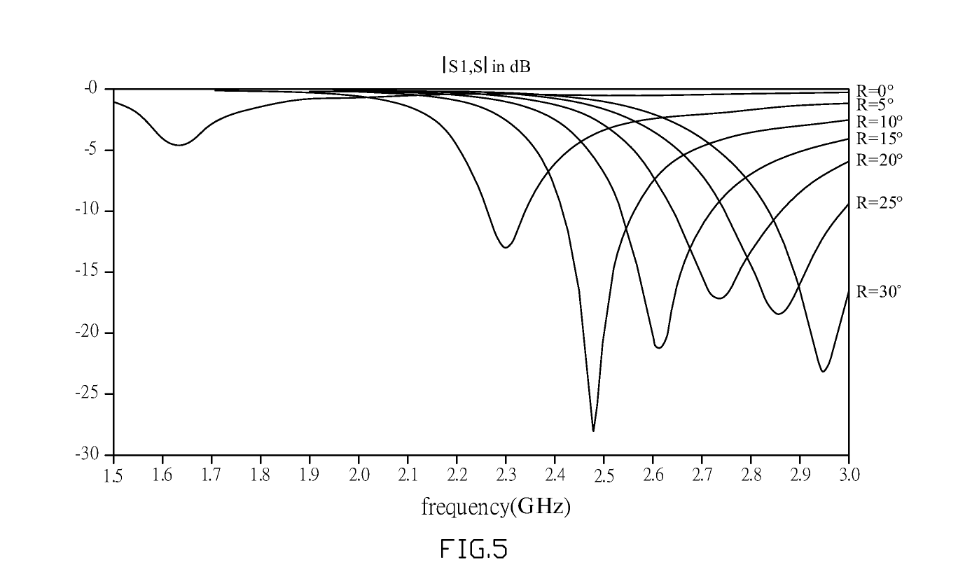

In addition, the reflection portion 12 further includes a fine-tune portion 14 coupled to an end of the reflection portion 12, wherein the fine-tune portion 14 has a length greater than the length of the connecting portion 13 as shown in FIGS. 3 and 4, and the fine-tune portion 14 is extended outwardly in a direction towards the antenna radiation portion 11, and the fine-tune portion 14 and the antenna radiation portion 11 form an opening 15, and the fine-tune portion 14 and the reflection portion 12 constitute an included angle R, and the included angle R can be tuned to adjust the frequency band of the antenna device. In FIG. 5, the effect of different included angles R (wherein R=0˜30 degrees) on the frequency is shown, wherein the greater the included angle R, the greater is the shift towards the high frequency; and the smaller the included angle R, the greater is the shift towards the low frequency.

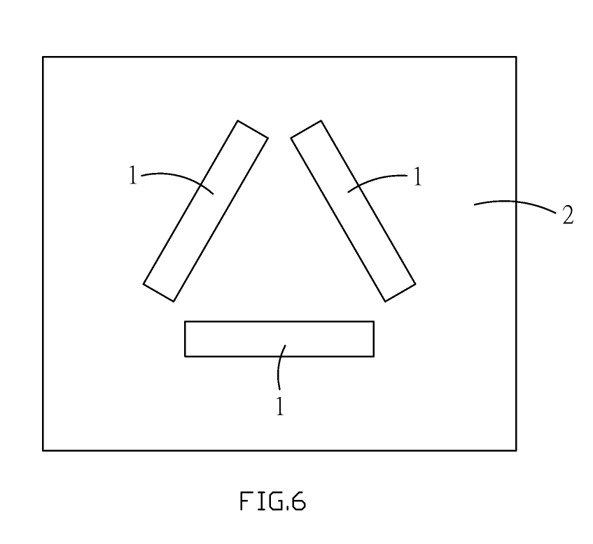

The antenna device of the present invention further comprises a substrate provided for installing a plurality of antenna devices, and such arrangement can be applied in a multi-input multi-output (MIMO) device as shown in FIG. 6, and the substrate 2 includes three antenna devices 1 installed thereon and arranged into a triangle, and an included angle defined by two adjacent antenna devices 1 is equal to 60 degrees in order to achieve the omni-directional effect, enhance the receiving effect of the antenna, and adjust the position of each antenna device according to user requirements.

The present invention improves over the prior art and complies with patent application requirements, and thus is duly filed for the patent application. While the invention has been described by device of specific embodiments, numerous modifications and variations could be made thereto by those generally skilled in the art without departing from the scope and spirit of the invention set forth in the claims.

What is claimed is:

1. An antenna device, formed by integrally bending a metal plate, and comprising:
an antenna radiation portion, having a longer slot hole, a shorter slot hole and a feeding point, and the feeding point being disposed at a central position of the longer slot hole or the shorter slot hole;
a reflection portion, disposed in parallel with the antenna radiation portion; and
a connecting portion, disposed between the antenna radiation portion and the reflection portion, for connecting the antenna radiation portion and the reflection portion.

2. The antenna device of claim 1, wherein the reflection portion further includes a fine-tune portion coupled to an end of the reflection portion, and the fine-tune portion is extended outwardly in a direction towards the antenna radiation portion, and the fine-tune portion and the antenna radiation portion form an opening

3. The antenna device of claim 2, wherein the fine-tune portion has a length greater than the length of the connecting portion.

4. The antenna device of claim 1, wherein the antenna radiation portion has a height equal to the height of the reflection portion.

5. The antenna device of claim 1, wherein the connecting portion includes a plurality of fixing portions disposed around the periphery of the connecting portion.

6. The antenna device of claim 1, further comprising a substrate for installing a plurality of antenna devices.

7. The antenna device of claim 6, wherein the substrate includes three antenna devices installed thereon, and the antenna devices are arranged into a triangle, and an included angle between two adjacent antenna devices is equal to 60 degrees.
